(19) United States
(12) Patent Application Publication
(10) Pub. No.: US 2024/0046381 A1
(43) Pub. Date: Feb. 8, 2024

(54) INFORMATION PROCESSING METHOD, INFORMATION PROCESSING DEVICE, AND RECORDING MEDIUM

(71) Applicant: Panasonic Intellectual Property Corporation of America, Torrance, CA (US)

(72) Inventors: Kotaro SAKATA, Osaka (JP); Tetsuji FUCHIKAMI, Osaka (JP)

(21) Appl. No.: 18/380,777

(22) Filed: Oct. 17, 2023

Related U.S. Application Data
(63) Continuation of application No. PCT/JP2022/003295, filed on Jan. 28, 2022.

(30) Foreign Application Priority Data
Apr. 30, 2021 (JP) 2021-077052

(51) Int. Cl. G06Q 50/06

(52) U.S. Cl. CPC G06Q 50/06

(57) ABSTRACT

An information processing method includes: obtaining history information about a use history of a home electric appliance by a user; calculating a CO₂ reduction effect of the user based on the history information obtained; analyzing a behavioral characteristic of the user based on the history information obtained, the behavioral characteristic being a characteristic related to at least one of a private benefit or a social benefit; generating content related to the CO₂ reduction effect, based on an analysis result of the behavioral characteristic; and outputting the content generated.

### CROSS REFERENCE TO RELATED APPLICATIONS

This is a continuation application of PCT International Application No. PCT/JP2022/003295 filed on Jan. 28, 2022, designating the United States of America, which is based on and claims priority of Japanese Patent Application No. 2021-077052 filed on Apr. 30, 2021. The entire disclosures of the above-identified applications, including the specifications, drawings and claims are incorporated herein by reference in their entirety.

### FIELD

The present disclosure relates to an information processing method, an information processing device, and a recording medium.

### BACKGROUND

In recent years, various efforts have been made to reduce carbon dioxide (hereafter also referred to as “CO₂”) emissions in order to prevent global warming. For example, Patent Literature (PTL) 1 discloses a device that calculates CO₂ emissions associated with the disposal of unwanted printed matter and displays the calculation result.

### CITATION LIST

### Patent Literature

PTL 1: Japanese Patent No. 4941484

### SUMMARY

### Technical Problem

There are individual differences in whether users, having seen the displayed CO₂ emissions, take action to reduce CO₂ emissions. With the technique disclosed in PTL 1, the same display mode is used for each user, and therefore it is difficult to effectively encourage each user to reduce CO₂ emissions.

In view of this, the present disclosure provides an information processing method, information processing device, and recording medium for generating content that can effectively encourage reduction of CO₂ emissions.

### Solution to Problem

An information processing method according to an aspect of the present disclosure includes: obtaining history information about a use history of a home electric appliance by a user; calculating a CO₂ reduction effect of the user based on the history information obtained; analyzing a behavioral characteristic of the user based on the history information obtained, the behavioral characteristic being a characteristic related to at least one of a private benefit or a social benefit; generating content related to the CO₂ reduction effect, based on an analysis result of the behavioral characteristic; and outputting the content generated.

An information processing device according to an aspect of the present disclosure includes: an obtainer that obtains history information about a use history of a home electric appliance by a user; a calculator that calculates a CO₂ reduction effect of the user based on the history information obtained; an analyzer that analyzes a behavioral characteristic of the user based on the history information obtained, the behavioral characteristic being a characteristic related to at least one of a private benefit or a social benefit; a generator that generates content related to the CO₂ reduction effect, based on an analysis result of the behavioral characteristic; and an outputter that outputs the content generated.

A recording medium according to an aspect of the present disclosure is a non-transitory computer-readable recording medium having recorded thereon a computer program for causing a computer to execute the above-described information processing method.

### Advantageous Effects

With the information processing method, etc. according to an aspect of the present disclosure, it is possible to generate content that can effectively encourage reduction of CO₂ emissions.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating the structure of an information processing system according to an embodiment.

FIG. 2 is a diagram illustrating the behavioral characteristic of an individual according to the embodiment.

FIG. 3 is a flowchart illustrating the operation of the information processing system according to the embodiment.

FIG. 4 is a table illustrating the relationship between actions and CO₂ reduction amounts according to the embodiment.

FIG. 5 is a flowchart illustrating the details of Step S30 illustrated in FIG. 3.

FIG. 6A is a diagram illustrating a display example of content A according to the embodiment.

FIG. 6B is a diagram illustrating a display example of content B according to the embodiment.

FIG. 7A is a diagram illustrating another display example of content A according to the embodiment.

FIG. 7B is a diagram illustrating another display example of content B according to the embodiment.

FIG. 8 is a diagram illustrating the behavioral characteristic of an individual according to a variation of the embodiment.

FIG. 9 is a diagram illustrating a display example of content C according to a variation of the embodiment.

### DESCRIPTION OF EMBODIMENT

### Underlying Knowledge Forming Basis of the Present Disclosure

In recent years, technologies and appliances with high environmental performance such as energy saving are spreading in society through improvement in efficiency, development of innovative technologies, etc. Appropriate use of such technologies and appliances can achieve desired energy saving.

The way such a technology or appliance is used, however, may vary greatly depending on each user's behavior pattern. For example, in the case where a user uses an appliance with high environmental performance, there is a possibility that the high environmental performance of the appliance cannot be fully exhibited due to, for example, inefficient use. For example, even when a display for encouraging reduction of CO₂ emissions is made to the user, whether the user takes action to reduce CO₂ emissions (for example, operates the appliance under operating conditions for fully exhibiting the environmental performance) varies from individual to individual.

For example, there are individual differences in how a display for encouraging reduction of CO₂ emissions resonates with users who see the display. It is thus necessary to provide encouragement (e.g. display) for CO₂ emissions reduction personalized according to user attributes, such as those interested in reducing CO₂ emissions and those not interested in reducing CO₂ emissions.

There may also be individual differences in whether users take action, depending on their environments, social statuses, economic statuses, etc. It is thus necessary to provide encouragement for CO₂ emissions reduction personalized according to each user's place of residence (e.g. urban or rural, etc.), the climate of the place of residence (e.g. warm region or cold region, etc.), and the regional characteristics, culture, etc. of the user's place of residence.

Hence, for effective reduction of CO₂ emissions, it is important to not only improve the environmental performance of appliances but also provide encouragement according to each user.

In view of this, the inventors of the present application conducted extensive research on an information processing method, etc. for generating content that can effectively encourage reduction of CO₂ emissions, and discovered the following information processing method, etc.

An information processing method according to an aspect of the present disclosure includes: obtaining history information about a use history of a home electric appliance by a user; calculating a CO₂ reduction effect of the user based on the history information obtained; analyzing a behavioral characteristic of the user based on the history information obtained, the behavioral characteristic being a characteristic related to at least one of a private benefit or a social benefit; generating content related to the CO₂ reduction effect, based on an analysis result of the behavioral characteristic; and outputting the content generated.

In this way, content according to the analysis result of the behavioral characteristic of the user can be generated. That is, the content generated varies according to the behavioral characteristic of the user. Thus, content that can effectively encourage reduction of CO₂ emissions can be generated as compared with content uniformly generated for each user.

For example, the information processing method may further include: calculating a macro influence indicating an influence when the CO₂ reduction effect calculated is extended to a predetermined area in which a plurality of persons exist, and a micro influence indicating an influence on the user based on the CO₂ reduction effect, and the content generated in the generating may be content for presenting at least one of the macro influence or the micro influence.

In this way, reduction of CO₂ emissions can be effectively encouraged by the content for presenting at least one of macro influence or micro influence.

For example, the behavioral characteristic may be a characteristic related to which of the private benefit and the social benefit is given importance, and the content generated in the generating may be: content emphasizing the macro influence out of the macro influence and the micro influence when the behavioral characteristic of the user gives importance to the social benefit; and content emphasizing the micro influence out of the macro influence and the micro influence when the behavioral characteristic of the user gives importance to the private benefit.

In this way, in the case where the user gives importance to the social benefit, display is made with emphasis on the influence (e.g. social gain) in the predetermined area, with it being possible to effectively encourage the user to reduce CO₂ emissions. In the case where the user gives importance to the private benefit, display is made with emphasis on the influence on the user (e.g. the user's personal gain), with it being possible to effectively encourage the user to reduce CO₂ emissions. Thus, content is generated according to whether the user gives importance to the social benefit or the private benefit. Such content can encourage reduction of CO₂ emissions more effectively.

For example, the predetermined area may be a predetermined geographical region.

In this way, content that includes the macro influence in the predetermined geographical region can be generated. Displaying such content including geographical region-scale macro influence can further encourage the user who gives importance to the social benefit to reduce CO₂ emissions.

For example, the predetermined area may be a predetermined country.

In this way, content that includes the macro influence in the predetermined country can be generated. Displaying such content including country-scale macro influence can further encourage the user who gives importance to the social benefit to reduce CO₂ emissions.

For example, the predetermined area may be the earth.

In this way, content that includes the macro influence on the earth can be generated. Displaying such content including global-scale macro influence can further encourage the user who gives importance to the social benefit to reduce CO₂ emissions.

For example, the macro influence may include a result of determination of whether a target set in the predetermined area for mitigating climate change is achievable.

In this way, the determination result of whether the target for mitigating climate change is achievable is displayed, with it being possible to more effectively encourage the user who gives importance to the social benefit to reduce CO₂ emissions.

For example, the micro influence may include an amount of a monetary gain received by the user.

In this way, the amount of monetary gain received by the user is displayed, with it being possible to more effectively encourage the user who gives importance to the private benefit to reduce CO₂ emissions.

For example, the CO₂ reduction effect may include a CO₂ reduction amount, and in the analyzing, the behavioral characteristic may be analyzed based on the CO₂ reduction amount calculated.

In this way, the behavioral characteristic of the user can be analyzed based on the actual CO₂ reduction amount.

For example, the analyzing may include calculating a score of the CO₂ reduction effect based on the history information obtained, and analyzing the behavioral characteristic based on the score calculated.

In this way, the behavioral characteristic of the user can be analyzed based on the score that is based on the history information.

An information processing device according to an aspect of the present disclosure includes: an obtainer that obtains history information about a use history of a home electric appliance by a user; a calculator that calculates a CO₂ reduction effect of the user based on the history information obtained; an analyzer that analyzes a behavioral characteristic of the user based on the history information obtained, the behavioral characteristic being a characteristic related to at least one of a private benefit or a social benefit; a generator that generates content related to the CO₂ reduction effect, based on an analysis result of the behavioral characteristic; and an outputter that outputs the content generated. A recording medium according to an aspect of the present disclosure is a non-transitory computer-readable recording medium having recorded thereon a computer program for causing a computer to execute the above-described information processing method.

These have the same effects as the information processing method described above.

These general and specific aspects may be implemented using a system, a method, an integrated circuit, a computer program, or a computer-readable non-transitory recording medium such as CD-ROM, or any combination of a system, a method, an integrated circuit, a computer program, and a recording medium. The program may be stored in the recording medium beforehand, or supplied to the recording medium via a wide area communication network such as the Internet.

Certain exemplary embodiments will be described in detail below with reference to the drawings.

Each of the exemplary embodiments described below shows a general or specific example. The numerical values, shapes, elements, the arrangement and connection of the elements, steps, the processing order of the steps etc. illustrated in the following exemplary embodiments are mere examples, and therefore do not limit the scope of the present disclosure. For example, the numerical values are not expressions of strict meanings only, but are expressions of meanings including substantially equivalent ranges, for example, allowing for a difference of about several percent. Of the elements in the embodiments described below, the elements not recited in any one of the independent claims are described as optional elements.

Each drawing is a schematic and does not necessarily provide precise depiction. For example, scale and the like are not necessarily consistent throughout the drawings. The substantially same elements are given the same reference marks throughout the drawings, and repeated description is omitted or simplified.

In the specification, the terms indicating the relationships between elements, such as “same” and “equal”, the numerical values, and the numerical ranges are not expressions of strict meanings only, but are expressions of meanings including substantially equivalent ranges, for example, allowing for a difference of about several percent (e.g. about 5%).

### Embodiment

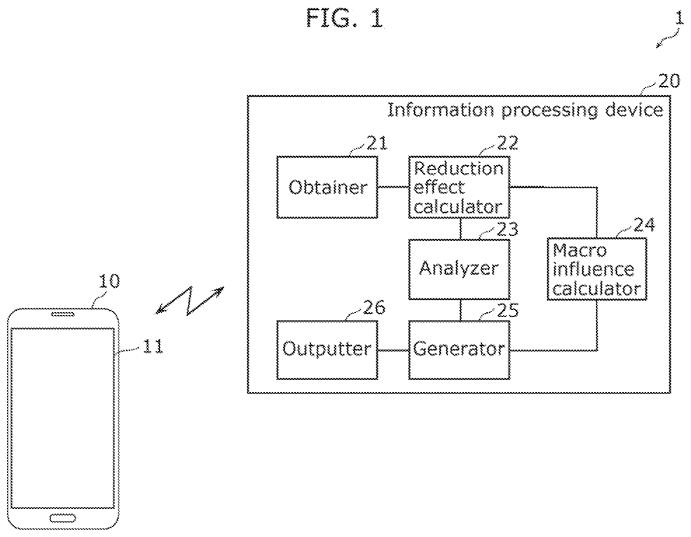

An information processing system according to an embodiment will be described below with reference to FIGS. 1 to 7B.

### 1. Structure of Information Processing System

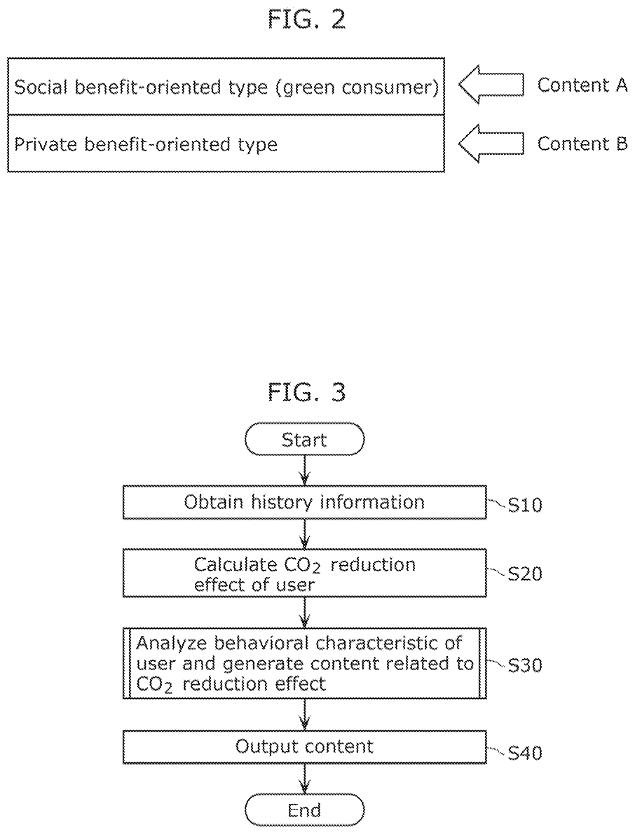

First, the structure of the information processing system according to this embodiment will be described with reference to FIGS. 1 and 2. FIG. 1 is a block diagram illustrating the structure of information processing system 1 according to this embodiment.

As illustrated in FIG. 1, information processing system 1 includes terminal device 10 and information processing device 20. Terminal device 10 and information processing device 20 are communicably connected to each other.

Terminal device 10 presents content for CO₂ emissions reduction generated by information processing device 20 to the user. Terminal device 10 presents the information to the user by, for example, images, sound, etc. In this embodiment, terminal device 10 includes display 11, and displays the content to the user as an image. Display 11 is implemented by a liquid crystal display device or the like, without being limited thereto.

Terminal device 10 is, for example, a mobile terminal such as a smartphone or tablet possessed by the user. Terminal device 10 is, however, not limited to such, and is any device that has a presentation function and a communication function. Terminal device 10 may be, for example, a stationary personal computer. Terminal device 10 may be a device worn by the user, such as a wearable terminal.

Information processing device 20 calculates the amount of CO₂ emissions reduction of each individual based on the behavior of the individual, for example. For example, information processing device 20 generates content for CO₂ emissions reduction for the user, using at least history information about the use history of at least one home electric appliance by the user. In other words, information processing device 20 does not generate the same content for each user. The behavior of the individual includes, for example, the individual's operation on the home electric appliance.

The home electric appliance is, for example, a home electric appliance corresponding to the user. For example, the home electric appliance may be a home electric appliance in the user's home, or a home electric appliance used by the user at a specific location such as the workplace. The home electric appliance has a communication function, and is an IoT (Internet of things) appliance (IoT home electric appliance). The home electric appliance may be, for example, an appliance having a wireless communication function and communicable with information processing device 20 via a router. The home electric appliance may include, for example, at least one selected from an air conditioner, a refrigerator, a lighting device, a rice cooker, a microwave oven, a personal computer, a gas water heater, and a display device. The use history includes information with which the CO₂ emissions directly or indirectly caused by operating the home electric appliance can be calculated. For example, the use history may include at least one selected from the setting conditions, the number of uses, and the use time of the home electric appliance. The setting conditions include, for example, at least one selected from temperature, humidity, and brightness. The number of uses includes, for example, at least one selected from the number of times the home electric appliance was turned on and the number of times the home electric appliance was operated. For example, in the case where the home electric appliance is a refrigerator, the number of uses may include the number of times the door of the refrigerator was opened and closed. The use time indicates the time during which the home electric appliance was operated. The use history may include the amount of power consumed by the home electric appliance, for example.

Information processing device 20 includes obtainer 21, reduction effect calculator 22, analyzer 23, macro influence calculator 24, generator 25, and outputter 26. Information processing device 20 is a computer including a processor (e.g. microprocessor), a user interface, a communication interface, memory, and the like. The user interface includes, for example, input/output devices such as a display, a keyboard, and a touch panel. The memory is ROM (read only memory), RAM (random access memory), etc., and is capable of storing a control program (computer program) executed by the processor. Obtainer 21, reduction effect calculator 22, analyzer 23, macro influence calculator 24, generator 25, and outputter 26 are implemented by the processor operating according to the control program. Information processing device 20 may include one memory or include a plurality of memories.

Obtainer 21 obtains the history information about the use history of the home electric appliance by the user. For example, obtainer 21 may be communicably connected to the home electric appliance installed in the user's home, and obtain the history information about the use history from the home electric appliance. Alternatively, obtainer 21 may obtain the history information from a server device that manages the use history. Obtainer 21 includes, for example, a communication circuit.

Obtainer 21 may obtain, in addition to the history information, information indicating whether the user is vegetarian, whether the user uses an automobile for personal transportation, whether the user has switched to grid power derived from renewable energy, whether the user uses a high-efficiency water heater, and/or whether a power supply system derived from renewable energy such as solar power generation or wind power generation is installed. Moreover, obtainer 21 may obtain, in addition to the history information, information indicating the user's environmental consciousness, such as whether the user shortens the idling time of the automobile and whether the user carries a reusable shopping bag. For example, these information are obtained through input from the user. Obtainer 21 may obtain these information from terminal device 10, for example.

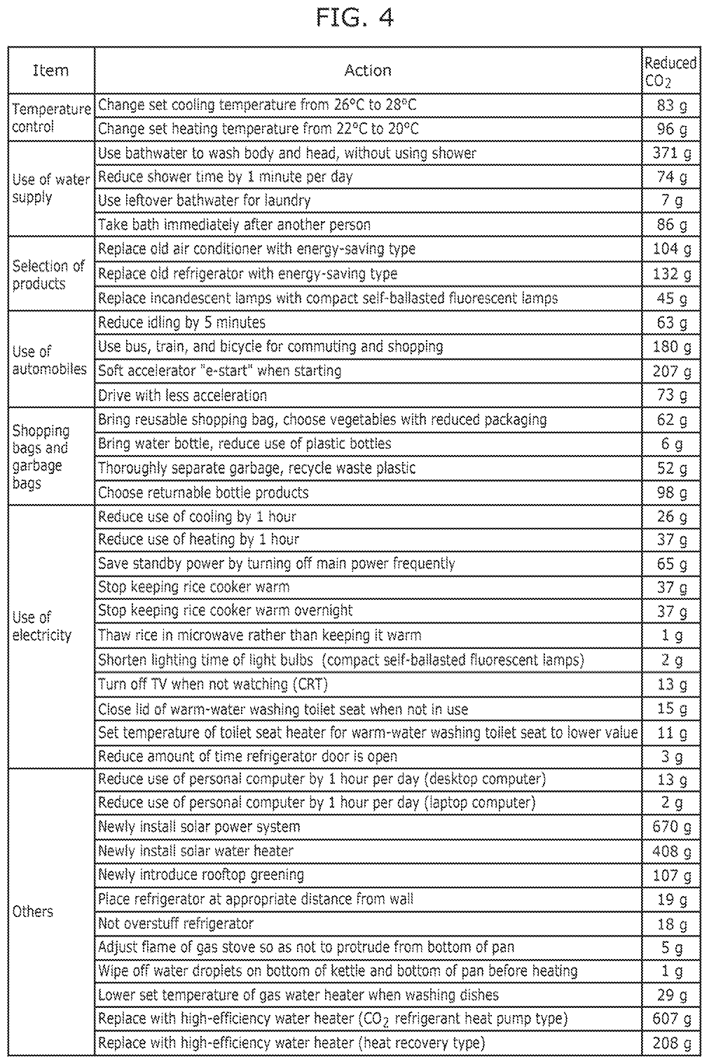

Reduction effect calculator 22 calculates the CO₂ reduction effect of the user based on the history information. For example, reduction effect calculator 22 calculates, as the CO₂ reduction effect of the user, the cumulative CO₂ reduction effect of the user in a predetermined period based on the use history of the home electric appliance by the user and a table (see, for example, FIG. 4 (described later)) associating the use history and the CO₂ reduction amount. The predetermined period is not limited, and may be one day, one week, or one month. Reduction effect calculator 22 is an example of a calculator.

Analyzer 23 analyzes the behavioral characteristic of the user related to at least one of the private benefit or the social benefit, based on the history information. For example, analyzer 23 may analyze the behavioral characteristic of the user based on at least one of the CO₂ reduction amount calculated by reduction effect calculator 22 or a score value obtained by scoring the CO₂ reduction effect. The behavioral characteristic is, for example, a characteristic related to which of the social benefit and the private benefit is given importance. The social benefit means benefiting other people (e.g. people in society living in a country or on the earth) even though not benefiting the user. The private benefit means benefiting the user even though not benefiting other people. There are individual differences in which of the social benefit and the private benefit is given importance.

The behavioral characteristic will be described below, with reference to FIG. 2. FIG. 2 is a diagram illustrating the behavioral characteristic of an individual according to this embodiment.

The behavioral characteristics include, for example, social benefit-oriented type and private benefit-oriented type. The social benefit-oriented type gives importance to the social benefit out of the social benefit and the private benefit. The social benefit-oriented type is a consumer who acts in an environmentally friendly way, and is also called a green consumer. The private benefit-oriented type gives importance to the private benefit out of the social benefit and the private benefit. For example, the private benefit-oriented type tends to have less interest in CO₂ reduction than the social benefit-oriented type.

Referring back to FIG. 1, macro influence calculator 24 calculates a macro influence that indicates the influence when the O₂ reduction effect calculated by reduction effect calculator 22 is extended to a predetermined first area in which a plurality of persons exist. For example, macro influence calculator 24 calculates, as the macro influence, the CO₂ reduction effect in the predetermined first area assuming that each of the plurality of persons existing in the predetermined first area achieves the same level of CO₂ reduction effect as the user. The predetermined first area may be a predetermined geographical region (e.g. a municipality), a predetermined country (e.g. Japan), or the earth (e.g. the whole earth). In other words, macro influence calculator 24 calculates the CO₂ reduction effect on the scale of a predetermined region, a predetermined country, or the earth, as the macro influence. The predetermined geographical region may be the geographical region in which the user lives. The predetermined country may be the country in which the user lives. The predetermined first area may be set in advance or obtained from the user, for example.

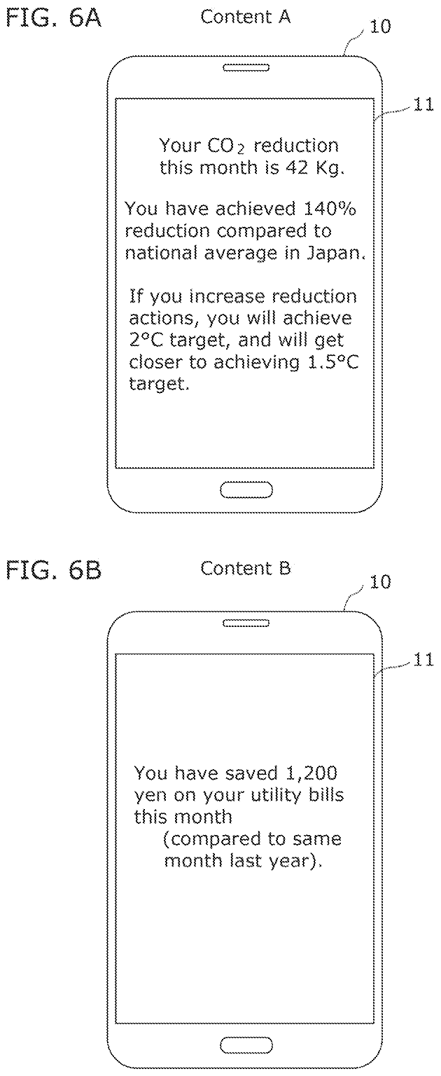

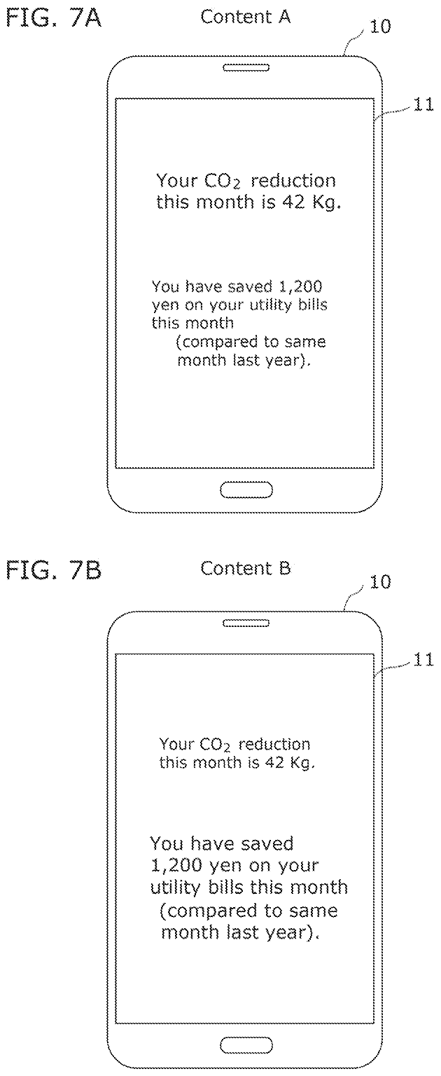

Generator 25 generates, based on the analysis result of the behavioral characteristic, content related to the CO₂ reduction effect according to the analysis result. Generator 25 generates different content for each analysis result. In this embodiment, in the case where the behavioral characteristic of the user gives importance to the social benefit, generator 25 generates content (see, for example, content A illustrated in FIGS. 6A and 7A (described later)) emphasizing the macro influence out of the macro influence and the micro influence (described in detail later). In other words, generator 25 generates content A in the case where the user is the social benefit-oriented type. In this embodiment, in the case where the behavioral characteristic of the user gives importance to the private benefit, generator 25 generates content (see, for example, content B illustrated in FIGS. 6B and 7B (described later)) emphasizing the micro influence out of the macro influence and the micro influence. In other words, generator 25 generates content B in the case where the user is the private benefit-oriented type.

The micro influence is calculated based on the CO₂ reduction effect calculated by reduction effect calculator 22. The micro influence is information indicating the influence on the user (e.g. the benefit to the user) based on the CO₂ reduction effect (described in detail later). Although the micro influence is calculated by generator 25 in this embodiment, the present disclosure is not limited to such, and the micro influence may be calculated by reduction effect calculator 22 or the like.

The content can be regarded as indicating the result of the user's action (operation on the home electric appliance). The content is information for presenting at least one of the macro influence or the micro influence. Although the content is presented as an image in this embodiment, the content may be presented as sound or the like.

Outputter 26 outputs the content for CO₂ emissions reduction generated by generator 25 for the user, to terminal device 10 of the user. For example, outputter 26 includes a communication circuit, and can communicate with terminal device 10.

### 2. Operation of Information Processing System

Next, the operation of information processing system 1 having the above-described structure will be described with reference to FIGS. 3 to 7B. FIG. 3 is a flowchart illustrating the operation of information processing system 1 according to this embodiment.

As illustrated in FIG. 3, obtainer 21 obtains history information about the use history of at least one home electric appliance by each user (S10). For example, obtainer 21 obtains history information of each individual (each user) from the home electric appliance corresponding to the individual. Obtainer 21 obtains, for example, history information for a predetermined period. Obtainer 21 outputs the history information to reduction effect calculator 22.

Following this, reduction effect calculator 22 calculates the CO₂ reduction effect of the user based on the history information (S20). In this embodiment, reduction effect calculator 22 calculates the CO₂ reduction amount of the user as the CO₂ reduction effect of the user. Reduction effect calculator 22 calculates the CO₂ reduction amount of the user using the table illustrated in FIG. 4, for example.

FIG. 4 is a table illustrating the relationship between actions and CO₂ reduction amounts according to this embodiment (the source of FIG. 4 is Non Patent Literature (NPL) 1: Team Minus 6% (https://www.team-6.jp/) “Let's reduce 1 kg CO₂ per person per day!”). The table illustrated in FIG. 4 is, for example, obtained in advance and stored in a storage (not illustrated) included in information processing device 20.

As illustrated in FIG. 4, the table associates items, actions, and reduced CO₂ (CO₂ reduction amounts) with one another. The items represent categories related to CO₂ reduction, such as “temperature control”, “use of water supply”, “selection of products”, “use of automobiles”, “shopping bags and garbage bags”, “use of electricity”, and “others”. The actions include information based on actions of users effective in CO₂ reduction. Examples of the actions include changes in the setting conditions, etc. of a home electric appliance based on operation on the home electric appliance, replacement with an appliance or part having a predetermined function, purchase of an appliance having a predetermined function, and actions for power saving. The reduced CO₂ represents the CO₂ reduction amount resulting from the action of the user. The reduced CO₂ may be the CO₂ reduction amount per unit time.

Of the items illustrated in FIG. 4, information not obtainable from home electric appliances may be obtained through input from the user, for example. For example, reduction effect calculator 22 may obtain information on “how to use water supply”, “shopping bags and garbage bags”, and “others” from the user via obtainer 21.

Reduction effect calculator 22 may, for example, use a statistical value of CO₂ reduction amount in each home electric appliance as the CO₂ reduction effect of the user. The statistical value is, for example, an integrated value, but may be an average value, median value, maximum value, minimum value, mode value, or the like. The integrated value may be calculated by weighted addition of CO₂ reduction amounts in each home electric appliance.

Reduction effect calculator 22 outputs the calculated CO₂ reduction effect to analyzer 23 and macro influence calculator 24.

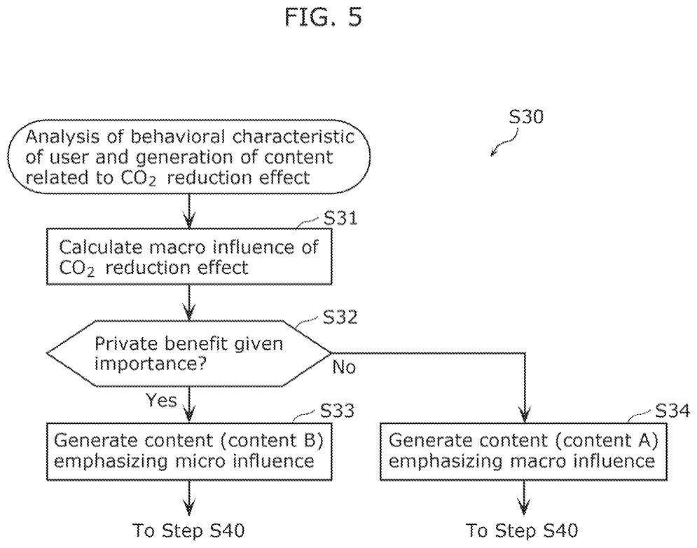

Referring back to FIG. 3, information processing device 20 analyzes the behavioral characteristic of the user related to at least one of the social benefit or the private benefit based on the history information, and generates content related to the CO₂ reduction effect based on the analyzed behavioral characteristic of the user and the CO₂ reduction effect (S30). Specifically, analyzer 23 analyzes the behavioral characteristic of the user, and generator 25 generates content according to the behavioral characteristic of the user. FIG. 5 is a flowchart illustrating the details of step S30 in FIG. 3.

As illustrated in FIG. 5, macro influence calculator 24 calculates a macro influence that indicates the influence (e.g. social gain) when the CO₂ reduction effect is extended to a predetermined second area in which a plurality of persons exist (S31). For example, macro influence calculator 24 calculates the macro influence based on the CO₂ reduction effect of the user and the number of persons existing in the predetermined second area (e.g. the number of residents in the predetermined second area). Macro influence calculator 24 calculates the macro influence in the predetermined second area when each of the plurality of persons achieves the same level of CO₂ reduction effect as the user, for example. The predetermined second area is any area in which a plurality of persons exist.

Macro influence calculator 24 may, based on the total CO₂ reduction effect (e.g. total CO₂ reduction amount) in the case where each of the plurality of persons achieves the same level of CO₂ reduction effect as the user, determine whether a first target set for mitigating climate change is achievable, and use the determination result as the macro influence. The first target is, for example, to keep the post-industrial temperature rise to not more than 2° C. (2° C. target), without being limited thereto.

Macro influence calculator 24 may make the foregoing determination based on a table associating the CO₂ reduction effect (e.g. CO₂ reduction amount) and its influence on temperature rise (temperature change). In the case where the first target is achievable, macro influence calculator 24 may further determine whether a second target harder than the first target is achievable based on the total CO₂ reduction effect (e.g. total CO₂ reduction amount). The second target is, for example, to keep the post-industrial temperature rise to not more than 1.5° C. (1.5° C. target), without being limited thereto. The effect of climate change mitigation is an example of the social benefit.

Macro influence calculator 24 may calculate information indicating the degree of achievement of the CO₂ reduction effect of the user. For example, macro influence calculator 24 may calculate the degree of achievement (e.g. achievement ratio) of the CO₂ reduction effect in the predetermined second area, based on the CO₂ reduction effect in the predetermined second area and the CO₂ reduction effect of the user. The degree of achievement may be included in the macro influence.

Macro influence calculator 24 outputs the calculated macro influence (information indicating the macro influence) to generator 25. Macro influence calculator 24 may output the CO₂ reduction effect (e.g. CO₂ reduction amount) calculated by reduction effect calculator 22 to generator 25, for example.

Following this, analyzer 23 determines whether the user gives importance to the private benefit, based on the CO₂ reduction effect (e.g. CO₂ reduction amount) calculated by reduction effect calculator 22 (S32). In other words, analyzer 23 determines in Step S32 whether the user is a person who gives importance to the social benefit or a person who gives importance to the private benefit. For example, in the case where the integrated value of the CO₂ reduction amount is not less than a predetermined value or the CO₂ reduction amount for a specific action is not less than a predetermined value, analyzer 23 determines that the user is a person who gives importance to the social benefit (social benefit-oriented type). In the case where the integrated value of the CO₂ reduction amount is less than the predetermined value or the CO₂ reduction amount for the specific action is less than the predetermined value, analyzer 23 determines that the user is a person who gives importance to the private benefit (private benefit-oriented type). Analyzer 23 outputs the analysis result to generator 25.

Analyzer 23 may calculate a score that quantifies the CO₂ reduction effect for each action of the user based on the history information obtained by obtainer 21, and analyze the behavior characteristic of the user based on a statistical value of the calculated scores. For example, a score is set for each action of the user. Scores may be set, for example, in such a manner that an action recommended in the predetermined first area or an action preselected by the user has a higher score.

In the case where the analysis result indicates that the behavioral characteristic of the user gives importance to the private benefit (S32: Yes), generator 25 generates content (e.g. content B) emphasizing the micro influence out of the macro influence and the micro influence (S33). In the case where the analysis result indicates that the behavioral characteristic of the user gives importance to the social benefit (S32: No), generator 25 generates content (e.g. content A) emphasizing the macro influence out of the macro influence and the micro influence (S34). Generator 25 then outputs the generated content to outputter 26.

Referring back to FIG. 3, outputter 26 outputs the content generated by generator 25 to terminal device 10 (S40). Thus, information processing device 20 can present the user with the content corresponding to the user. Information processing device 20 can therefore effectively encourage the user to reduce CO₂.

Display examples of content generated by generator 25 will be described below, with reference to FIGS. 6A to 7B. FIG. 6A is a diagram illustrating a display example of content A according to this embodiment. FIG. 6B is a diagram illustrating a display example of content B according to this embodiment. Content A is an example of content emphasizing the macro influence, and content B is an example of content emphasizing the micro influence.

As illustrated in FIG. 6A, display 11 in terminal device 10 displays content A including the macro influence out of the macro influence and the micro influence. Display 11 displays, for example, content A including only the macro influence out of the macro influence and the micro influence. In other words, generator 25 may generate content A including only the macro influence out of the macro influence and the micro influence in Step S34.

In the example in FIG. 6A, content including the macro influence, specifically, “Your CO₂ reduction this month is 42 Kg.”, “You have achieved 140% reduction compared to national average in Japan.”, and “If you increase reduction actions, you will achieve 2° C. target, and will get closer to achieving 1.5° C. target.”, is displayed. The information “Your CO₂ reduction this month is 42 Kg.” indicates the actual CO₂ reduction amount of the user, and is generated based on the CO₂ reduction effect (e.g. CO₂ reduction amount) calculated by reduction effect calculator 22.

By displaying the social benefit (e.g. climate change mitigation effect) as the macro influence as illustrated in FIG. 6A, information processing device 20 can effectively encourage a user interested in CO₂ reduction (e.g. a user who gives importance to the social benefit) to reduce CO₂, for example. Even if the content illustrated in FIG. 6A is displayed to a user who gives importance to the private benefit, the content is unlikely to resonate with the user who gives importance to the private benefit, and encouraging the user to reduce CO₂ is likely to be unsuccessful. Hence, the content illustrated in FIG. 6B may be displayed to the user who gives importance to the private benefit.

As illustrated in FIG. 6B, display 11 in terminal device 10 displays content B including the micro influence out of the macro influence and the micro influence. For example, generator 25 may generate content B including only the micro influence out of the macro influence and the micro influence in step S33.

In the example in FIG. 6B, content including the micro influence, specifically, “You have saved 1,200 yen on your utility bills this month (compared to same month last year).”, is displayed. Generator 25 calculates the micro influence based on a table associating the CO₂ reduction effect and its benefit to the user (e.g. the amount of monetary gain received by the user). In this embodiment, generator 25 calculates the user's personal gain as the micro influence. Although the benefit is a monetary gain received by the user in this example, the benefit is not limited to such, and may be, for example, a temporal gain received by the user. Generator 25 may calculate the micro influence in Step S33 in this way.

By displaying the influence on the user as the micro influence as illustrated in FIG. 6B, information processing device 20 can indirectly encourage a user not interested in CO₂ reduction (e.g. a user who gives importance to the private benefit) to reduce CO₂, for example. Even if the content illustrated in FIG. 6B is displayed to a user who gives importance to the social benefit, the content is unlikely to resonate with the user who gives importance to the social benefit, and encouraging the user to reduce CO₂ is likely to be unsuccessful.

Display examples on display 11 are not limited to those illustrated in FIGS. 6A and 6B. FIG. 7A is a diagram illustrating another display example of content A according to this embodiment. FIG. 7B is a diagram illustrating another display example of content B according to this embodiment.

As illustrated in FIG. 7A, display 11 in terminal device 10 may display content A that includes both the macro influence and the micro influence and in which the macro influence is more noticeable (emphasized) than the micro influence. In other words, generator 25 may generate content A in which the macro influence is more noticeable (emphasized) than the micro influence in Step S34. For example, generator 25 may generate content A in which the characters representing the macro influence are larger in size than the characters representing the micro influence in Step S34. Emphasizing the macro influence is not limited to displaying the macro influence in a larger character size. For example, generator 25 may generate content A in which the macro influence is more noticeable in color, display position, etc. than the micro influence.

As illustrated in FIG. 7B, display 11 in terminal device 10 may display content B that includes both the macro influence and the micro influence and in which the micro influence is more noticeable (emphasized) than the macro influence. In other words, generator 25 may generate content B in which the micro influence is more noticeable (emphasized) than the macro influence in Step S33. For example, generator 25 may generate content B in which the characters representing the micro influence are larger in size than the characters representing the macro influence in Step S33. Emphasizing the micro influence is not limited to displaying the micro influence in a larger character size. For example, generator 25 may generate content B in which the micro influence is more noticeable in color, display position, etc. than the macro influence.

Generator 25 may include, in the content, information about a benefit further received by the user in the case where the user changes his or her actions so as to further reduce CO₂ emissions, for example. For example, generator 25 may generate content A including information “If you lower air conditioner temperature by 1° C., you will get closer to achieving 1.5° C. target”, and generate content B including information “If you lower air conditioner temperature by 1° C., you can further save 200 yen on your utility bills”.

### Variation of Embodiment

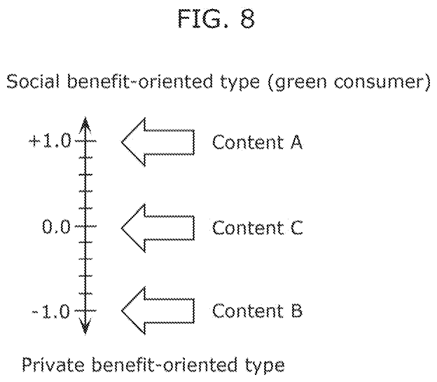

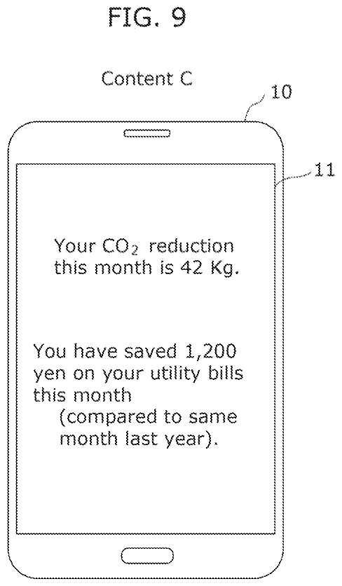

An information processing system according to a variation of the foregoing embodiment will be described below, with reference to FIGS. 8 and 9. In the following, the differences from the embodiment will be mainly described while omitting or simplifying the description of parts same as or similar to those in the embodiment. FIG. 8 is a diagram illustrating the behavioral characteristic of an individual according to this variation.

As illustrated in FIG. 8, the behavioral characteristic of a user may be expressed in three or more levels. In the example in FIG. 8, the behavioral characteristic is expressed in 11 levels from −1.0 to +1.0.

Level 0.0 means that both the social benefit and the private benefit are given importance, for example, neutral. The social benefit is given higher priority when the level is closer to +1.0, and the private benefit is given higher priority when the level is closer to −1.0.

Analyzer 23 according to this variation determines the level of the behavioral characteristic (behavioral characteristic level) of the user based on the CO₂ reduction amount calculated by reduction effect calculator 22. In Step S32 in FIG. 5, instead of determining whether the user gives importance to the private benefit, analyzer 23 may determine the behavioral characteristic level of the user based on the CO₂ reduction effect (e.g. CO₂ reduction amount) calculated by reduction effect calculator 22. For example, analyzer 23 determines the behavioral characteristic level based on a table associating each behavioral characteristic level and its corresponding CO₂ reduction effect. Determining the behavioral characteristic level is an example of analyzing the behavioral characteristic.

The table associates, for example, each behavioral characteristic level with the range of CO₂ reduction amount for the level, without being limited thereto. For example, analyzer 23 may determine the behavioral characteristic level according to whether the user takes a predetermined action. For example, in the case where the user newly installs a solar power generation system, analyzer 23 may determine that the behavioral characteristic level is 1.0. Analyzer 23 outputs the behavioral characteristic level to generator 25 as the analysis result.

Generator 25 generates content related to the CO₂ reduction effect according to the behavioral characteristic level. Generator 25 generates different content for each analysis result (for each behavioral characteristic level). In this variation, generator 25 generates content in which the macro influence out of the macro influence and the micro influence is more emphasized when the behavioral characteristic level of the user is closer to +1.0 (i.e. the social benefit is given more importance). For example, generator 25 may increase the size of the characters representing the macro influence relative to that of the micro influence in the generated content as the behavioral characteristic level of the user approaches +1.0 from 0.0. Generator 25 may generate content A illustrated in FIG. 6A or 7A in the case where the behavioral characteristic level of the user is +1.0, for example.

In this variation, generator 25 generates content in which the micro influence out of the macro influence and the micro influence is more emphasized when the behavioral characteristic level of the user is closer to −1.0 (i.e. the private benefit is given more importance). For example, generator 25 may increase the size of the characters representing the micro influence relative to that of the macro influence in the generated content as the behavioral characteristic level of the user approaches −1.0 from 0.0. Generator 25 may generate content B illustrated in FIG. 6B or 7B in the case where the behavioral characteristic level of the user is −1.0, for example.

In this variation, generator 25 generates content including both the macro influence and the micro influence in the case where the behavioral characteristic level of the user is 0.0 (e.g. both the social benefit and the private benefit are given importance). For example, generator 25 generates content in which the macro influence and the micro influence are emphasized equally. In other words, generator 25 generates content in which the macro influence and the micro influence are equal in display mode.

FIG. 9 is a diagram illustrating a display example of content C according to this variation. Content C is content generated in the case where the behavioral characteristic level of the user is 0.0.

As illustrated in FIG. 9, display 11 in terminal device 10 displays content C including the macro influence and the micro influence with the same degree of emphasis (e.g. the same character size). In the example in FIG. 9, the information indicating the macro influence “Your CO₂ reduction this month is 42 Kg.” and the information indicating the micro influence “You have saved 1,200 yen on your utility bills this month (compared to same month last year).” are displayed in the same character size.

The number of behavioral characteristic levels is three or more. Although the number of levels at which the social benefit is given importance and the number of levels at which the private benefit is given importance are the same in this example, the numbers may be different. Moreover, at least one of a level at which the social benefit is given importance or a level at which the private benefit is given importance may be determined.

Although the behavioral characteristic level of 0.0 in FIG. 8 indicates neutrality to the social benefit and the private benefit in this example, the present disclosure is not limited to such. The behavioral characteristic level of 0.0 may be the behavioral characteristic level of the user in the past. For example, FIG. 8 may illustrate the current behavioral characteristic level of the user relative to the past behavioral characteristic level of the user. In other words, FIG. 8 may illustrate the changes over time in the level at which the social benefit is given importance and the level at which the private benefit is given importance.

As described above, based on at least one of the level at which the behavioral characteristic of the user gives importance to the social benefit or the level at which the behavioral characteristic of the user gives importance to the private benefit, information processing device 20 generates content according to the level.

### Other Embodiments

While an information processing method, etc. according to one or more aspects have been described above by way of embodiments, the present disclosure is not limited to such embodiments. Other modifications obtained by applying various changes conceivable by a person skilled in the art to the embodiments and any combinations of the elements in different embodiments without departing from the scope of the present disclosure are also included in the scope of the present disclosure.

For example, the predetermined area described in the foregoing embodiment, etc. may be the inside of a building such as an apartment, a hospital, or a facility, or a part of the inside of the building. The predetermined area is any area containing a plurality of persons.

For example, each of the tables described in the foregoing embodiment, etc. is obtained in advance and stored in a storage (not illustrated) in information processing device 20.

Although the foregoing embodiment, etc. describe an example in which information processing device 20 generates content related to the CO₂ reduction effect, information processing device 20 may generate, for example, content related to the greenhouse gas reduction effect. That is, the content is not limited to being related to CO₂, and may be related to any other gas (e.g. methane, nitrous oxide, etc.) affecting the global environment (e.g. global warming).

The order in which the steps are performed in each flowchart is an example provided for specifically describing the presently disclosed technique, and order other than the above may be used. Part of the steps may be performed simultaneously (in parallel) with one or more other steps, and part of the steps may be omitted.

Each element in the foregoing embodiment, etc. may be configured in the form of an exclusive hardware product, or may be implemented by executing a software program suitable for the element. Each element may be implemented by means of a program executing unit, such as a CPU or a processor, reading and executing the software program recorded on a recording medium such as a hard disk or a semiconductor memory.

The division of the functional blocks in each block diagram is an example, and a plurality of functional blocks may be implemented as one functional block, one functional block may be divided into a plurality of functional blocks, or part of functions may be transferred to another functional block. Moreover, functions of a plurality of functional blocks having similar functions may be implemented by single hardware or software in parallel or in a time-sharing manner.

The communication method between terminal device 10 and information processing device 20 in the foregoing embodiment, etc. is not limited. Communication between terminal device 10 and information processing device 20 is, for example, wireless communication, but may be wired communication. The communication standard used for wireless communication or wired communication is not limited, and any communication standard may be used.

Information processing device 20 according to the foregoing embodiment, etc. may be implemented as a single device or a plurality of devices. In the case where information processing device 20 is implemented by a plurality of devices, the elements in information processing device 20 may be allocated to the plurality of devices in any way. In the case where information processing device 20 is implemented by a plurality of devices, the communication method between the plurality of devices is not limited, and may be wireless communication or wired communication. The communication method may be a combination of wireless communication or wired communication.

The elements described in the foregoing embodiment, etc. may be implemented by software, and may be typically implemented by LSI which is an integrated circuit. The elements may each be individually implemented as one chip, or may be partly or wholly implemented on one chip. While description has been made regarding LSI, there are different names such as IC, system LSI, super LSI, and ultra LSI, depending on the degree of integration. The circuit integration technique is not limited to LSIs, and dedicated circuits or general-purpose processors may be used to achieve the same. A field programmable gate array (FPGA) which can be programmed after manufacturing the LSI, or a reconfigurable processor where circuit cell connections and settings within the LSI can be reconfigured, may be used. Further, in the event of the advent of an integrated circuit technology which would replace LSIs by advance of semiconductor technology or a separate technology derived therefrom, such a technology may be used for integration of the elements.

A system LSI is a super-multifunctional LSI manufactured by integrating multiple processing units on a single chip, and specifically is a computer system including a microprocessor, ROM, RAM, and so forth. A computer program is stored in the ROM. The system LSI achieves its functions by the microprocessor operating according to the computer program.

One aspect of the present disclosure may be a computer program for causing a computer to execute each characteristic step included in the information processing method illustrated in any of FIGS. 3 and 5.

For example, the program may be a program to be executed by a computer. One aspect of the present disclosure may be a non-transitory computer-readable recording medium having such a program recorded thereon. For example, the program may be recorded on a recording medium and distributed or circulated. For example, by installing the distributed program in another device including a processor and causing the processor to execute the program, the processes can be performed by the device.

### INDUSTRIAL APPLICABILITY

The presently disclosed technique is useful for devices that encourage users to reduce CO₂ emissions.

1. An information processing method comprising:
obtaining history information about a use history of a home electric appliance by a user;
calculating a CO₂ reduction effect of the user based on the history information obtained;
analyzing a behavioral characteristic of the user based on the history information obtained, the behavioral characteristic being a characteristic related to at least one of a private benefit or a social benefit;
generating content related to the CO₂ reduction effect, based on an analysis result of the behavioral characteristic; and
outputting the content generated.

2. The information processing method according to claim 1, further comprising:
calculating a macro influence indicating an influence when the CO₂ reduction effect calculated is extended to a predetermined area in which a plurality of persons exist, and a micro influence indicating an influence on the user based on the CO₂ reduction effect, wherein the content generated in the generating is content for presenting at least one of the macro influence or the micro influence.

3. The information processing method according to claim 2,
wherein the behavioral characteristic is a characteristic related to which of the private benefit and the social benefit is given importance, and
the content generated in the generating is:
content emphasizing the macro influence out of the macro influence and the micro influence when the behavioral characteristic of the user gives importance to the social benefit; and
content emphasizing the micro influence out of the macro influence and the micro influence when the behavioral characteristic of the user gives importance to the private benefit.

4. The information processing method according to claim 2,
wherein the predetermined area is a predetermined geographical region.

5. The information processing method according to claim 2,
wherein the predetermined area is a predetermined country.

6. The information processing method according to claim 2,
wherein the predetermined area is the earth.

7. The information processing method according to claim 2,
wherein the macro influence includes a result of determination of whether a target set in the predetermined area for mitigating climate change is achievable.

8. The information processing method according to claim 2,
wherein the micro influence includes an amount of a monetary gain received by the user.

9. The information processing method according to claim 1,
wherein the CO₂ reduction effect includes a CO₂ reduction amount, and
in the analyzing, the behavioral characteristic is analyzed based on the CO₂ reduction amount calculated.

10. The information processing method according to claim 1,
wherein the analyzing includes calculating a score of the CO₂ reduction effect based on the history information obtained, and analyzing the behavioral characteristic based on the score calculated.

11. An information processing device comprising:
an obtainer that obtains history information about a use history of a home electric appliance by a user;
a calculator that calculates a CO₂ reduction effect of the user based on the history information obtained;
an analyzer that analyzes a behavioral characteristic of the user based on the history information obtained, the behavioral characteristic being a characteristic related to at least one of a private benefit or a social benefit;
a generator that generates content related to the CO₂ reduction effect, based on an analysis result of the behavioral characteristic; and
an outputter that outputs the content generated.

12. A non-transitory computer-readable recording medium having recorded thereon a computer program for causing a computer to execute the information processing method according to claim 1.
